(19) United States
(12) Patent Application Publication
(10) Pub. No.: US 2009/0058360 A1
(43) Pub. Date: Mar. 5, 2009

(54) SELF-CHARGING PORTABLE ELECTRONIC DEVICE

(75) Inventor: CHIA-HUNG KUO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/959,275

(22) Filed: Dec. 18, 2007

(30) Foreign Application Priority Data
Aug. 28, 2007 (CN) 200710201499.2

(51) Int. Cl. H02J 7/14; H02K 5/00

(52) U.S. Cl. 320/114; 322/1

(57) ABSTRACT

A self-charging portable electronic device (100) is provided. A self-charging portable electronic device includes a rechargeable battery (80) and a generator (30) configured for charging the rechargeable battery. The generator includes at least one pair of magnetic N-pole (41) and S-pole (40), a charging circuit module (60), a rotating member (50), and a wheel (70). Each pair of magnetic N-pole and S-pole is configured for creating a magnetic field. The charging circuit module electrically connects with the rechargeable battery. The rotating member is located in the magnetic field and electrically connecting with the charging circuit module. The wheel is configured to drive the rotating member to generate current to charge the rechargeable battery.

### BACKGROUND OF THE INVENTION

1. Field of the Invention

The present invention relates to self-charging portable electronic devices, particular to a self-charging portable electronic device with a built-in generator.

2. Description of Related Art

With the rapid development of wireless communication device, portable electronic device such as cellular phone, personal digital assistant, PDA and the like has become a necessity of consumer's daily life.

However, there is a hot problem yet to be solved, that is replenishment of electricity, also defined as the working energy for keeping the cellular phone reliably usable at all times. A tiny battery accommodated in limited space of a compact cellular phone is certainly unable to store sufficient energy to last satisfactorily for a long time. Normally, the capacity of an average cellular phone battery can only allow several hours talking time. Consequently, cellular phone users should always keep in mind to replace his/her phone's battery from time to time, so as to keep his/her cellular phone in a usable state. Although a rechargeable battery may be used, yet an AC charging source is not at all time available.

Therefore, a heretofore-unaddressed need exists in the art to eliminate the inconvenience inherent to the typical art as mentioned above.

### SUMMARY

In present aspect, a self-charging portable electronic device is provided. A self-charging portable electronic device includes a rechargeable battery and a generator configured for charging the rechargeable battery. The generator includes at least one pair of magnetic N-pole and S-pole, a charging circuit module, a rotating member, and a wheel. The charging circuit module electrically connects with the rechargeable battery. The rotating member is located within the magnetic field and electrically connecting with the charging circuit module. The wheel is configured to drive the rotating member to generate electric current to charge the rechargeable battery.

In another aspect, another self-charging portable electronic device is provided. The self-charging portable electronic device includes a rechargeable battery and a generator provided for charging the rechargeable battery. The generator includes at least one pair of magnetic N-pole and S-pole, a charging circuit module, a rotating member, and a wheel. The charging circuit module electrically connects with the rechargeable battery. The wheel is rotatably mounted within the self-charging portable electronic device. The rotating member, combined with the wheel, is located within the magnetic field and electrically connects with the charging circuit module, wherein the rotating member rotates to generate electric current to charge the rechargeable battery.

These and other aspects of the present invention will become more apparent from the following detailed description of the preferred embodiments taken in conjunction with the accompanying drawings, although variations and modifications therein may be affected without departing from the spirit and scope of the novel concepts of the disclosure.

### BRIEF DESCRIPTION OF THE DRAWINGS

Many aspects of the present self-charging portable electronic device can be better understood with reference to the following drawings. These drawings are not necessarily drawn to scale, the emphasis instead being placed upon clearly illustrating the principles of the present self-charging portable electronic device. Moreover, in the drawings like reference numerals designate corresponding parts throughout the several views. Wherever possible, the same reference numbers are used throughout the drawings to refer to the same or like elements of an embodiment.

FIG. 1 is an exploded, isometric view of a self-charging portable electronic device in accordance with a present embodiment;

FIG. 2 is an assembled view of a generator, a lower shell, and a rechargeable battery of the self-charging portable electronic device shown in FIG. 1; and

FIG. 3 is an isometric view of the self-charging portable electronic device shown in FIG.1 at a working status.

### DETAILED DESCRIPTION OF THE EMBODIMENTS

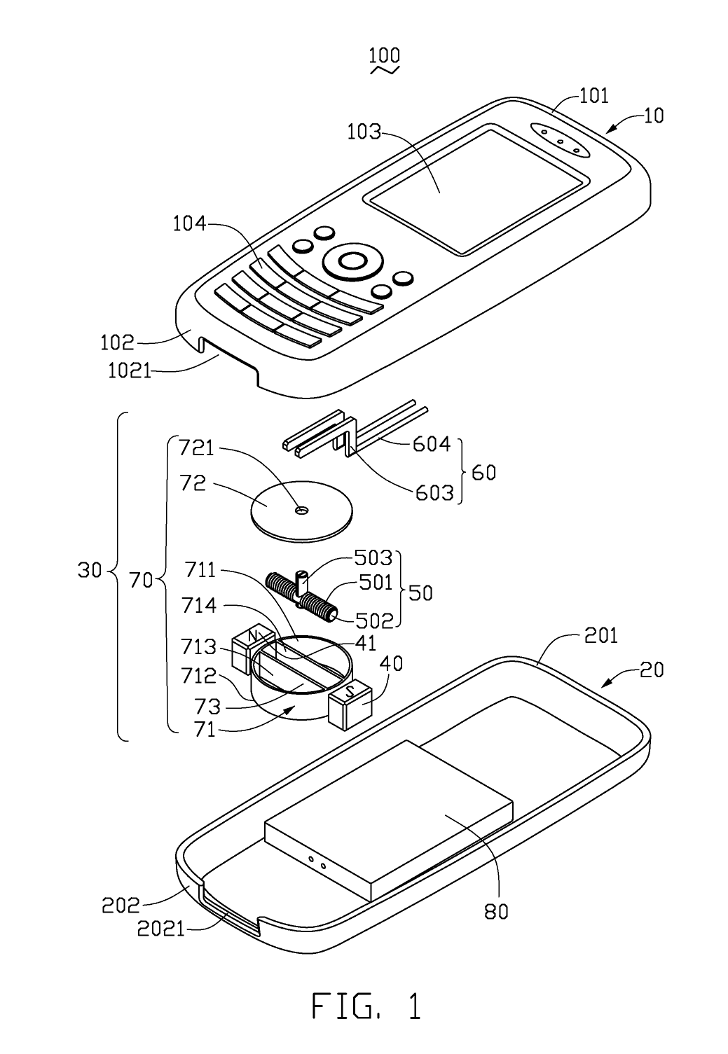

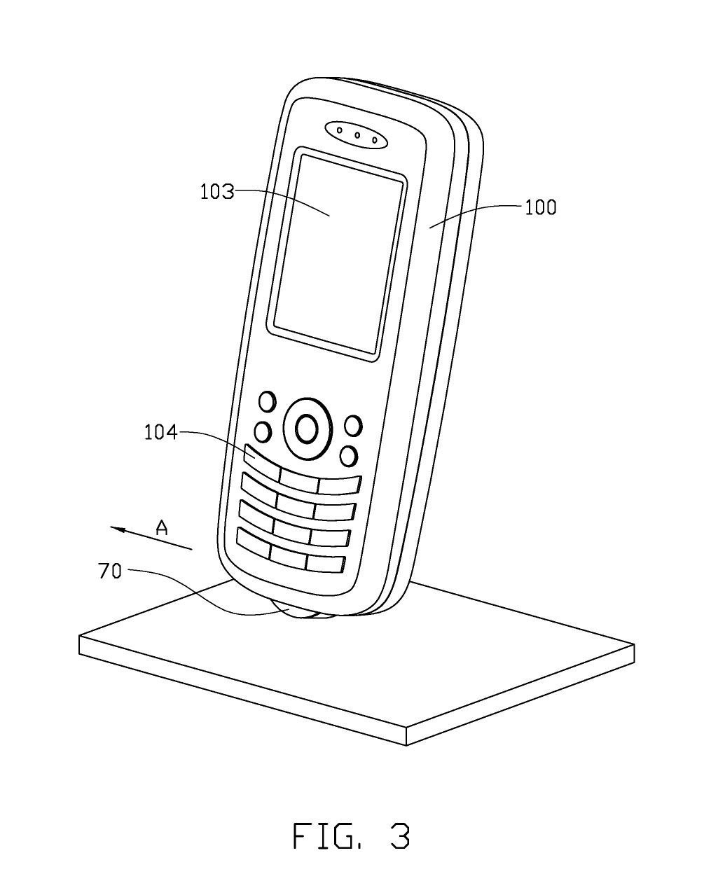

The present self-charging portable electronic device is described here in conjunction with the accompanying drawings in FIGS. 1 through 3. The self-charging portable electronic device can be the self-charging cellular phone, the self-charging personal digital handset, or the like. A self-charging cellular phone 100 (best shown in FIG. 3) is exemplified to illustrate the principle/sprit of the present invention.

Referring to FIG. 1, the self-charging cellular phone 100 includes an upper shell 10, a lower shell 20, a generator 30, and a rechargeable battery 80. The rechargeable battery 80 can be placed (e.g., attached/disposed) on the lower shell 20 and located within an accommodating space enclosed by the upper shell 10 and the lower shell 20. The generator 30 can be built in the self-charging cellular phone 100 and used to charge the rechargeable battery 80. The rechargeable battery 80 provides electric current to the self-charging cellular phone 100.

The upper shell 10 is a rectangular shell including an upper end wall 101, a lower end wall 102, and a sidewall (not labeled). The upper end wall 101 is located opposite to the lower end wall 102. The sidewall adjoins or interconnects with the upper end wall 101 and the lower end wall 102. The lower end wall 102 has a first opening 1021 defined therethrough. The sidewall defines a display window area 103 and a keypad area 104 therewith. The display window area 103 is located adjacent to the upper end wall 101, and the keypad area 104 is located adjacent to the lower end wall 102.

The lower shell 20 is a rectangular shell with an upper end wall 201 and a lower end wall 202. The upper end wall 201 and the lower end wall 202 respectively correspond to the upper end wall 101 and the lower end wall 102 of the upper shell 10. The lower shell 20 has a corresponding shape and size to that of the upper shell 10 so that the upper shell 10 and the lower shell 20 can cooperatively form an enclosed accommodating space to accommodate the rechargeable battery 80 and the generator 30 therein.

The lower end wall 202 of the lower shell 20 has a second opening 2021 defined therethrough. The second opening 2021 corresponds to the first opening 1021, whereby the two openings 1021 and 2021 are configured to cooperatively accommodate the generator 30 therein.

Referring also to FIG. 1, the generator 30 includes a pair of magnets S-pole 40 and N-pole 41, a rotating member 50, a charging circuit module 60, and a wheel 70. The wheel 70 is disposed between the magnets S-pole 40 and the N-pole 41. The rotating member 50 is received in the wheel 70 and rotates with the wheel 70. The charging circuit module 60 electrically connects/couples with the rotating member 50.

The pair of magnets S-pole 40 and N-pole 41 are advantageously attached (e.g., adhered) on the lower shell 20 and located adjacent to the second opening 2021 of the lower shell 20. The pair of magnets S-pole 40 and N-pole 41 is used to create a magnetic field facilitating the recharging of the generator 30.

The rotating member 50 is a general T-shape cylinder and includes a set of windings 501, an armature core 502, and a pair of ring collectors 503. The set of windings 501 is coiled around the armature core 502. The rotating member 50 functions to rotate in the magnetic field built up by the pair of magnets S-pole 40 and N-pole 41 and thus generates/induces electric current. The inducing current can be conducted to the charging circuit module 60 via the terminal conductors of the windings 501. Each of the pair of ring collectors 503 is a semi-cylinder with a semi-circular cross section. The ring collectors 503 are advantageously formed vertically at the middle portion of the armature core 502 on a same side and located proximate with each other. The two ring collectors 503 respectively electrically connect with the two terminal conductors of the windings 501.

The charging circuit module 60 includes a pair of electric brushes 603 and a pair of conductors 604. Each electric brush 603 is generally a L-shape rod. The two electric brushes 603 are arranged/distributed in parallel. Each electric brush 603 includes two ends, each of which is used to electrically contact/connect with one respective ring collector 503 or one respective conductor 604.

The wheel 70 includes a hollow circular cylinder 71 and a circular disk 72. The circular cylinder 71 is defined with an opening end 711, a closing end 712, and an accommodating cavity 713. The opening end 711 is located opposite to the closing end 712 and communicates with the accommodating cavity 713. The wheel 70 further includes two holding boards 73. The two holding boards 73 advantageously, essentially, and extends vertically from a middle portion of the closing end 712 to the opening end 711, thus dividing the accommodating cavity 713 to form a receiving cavity 714 therein. The receiving cavity 714 is configured to receive and hold the rotating member 50 in a manner that the rotating member 50 can rotate with the wheel 70.

The circular disk 72 has essentially the same shape and size as that of the opening end 711 of the wheel 70. The circular disk 72 is configured to cover the opening end 711. The circular disk 72 has a round hole 721 defined therethrough. The round hole 721 corresponds to the two ring collectors 503 and thus the ring collectors 503 can be rotatably inserted through the round hole 721.

The rechargeable battery 80 can be a nickel-cadmium rechargeable battery 80, or the like. The rechargeable battery 80 can advantageously attached (e.g., adhered) with the lower shell 20 and electrically connects with the charging circuit module 60 through the conductors 604.

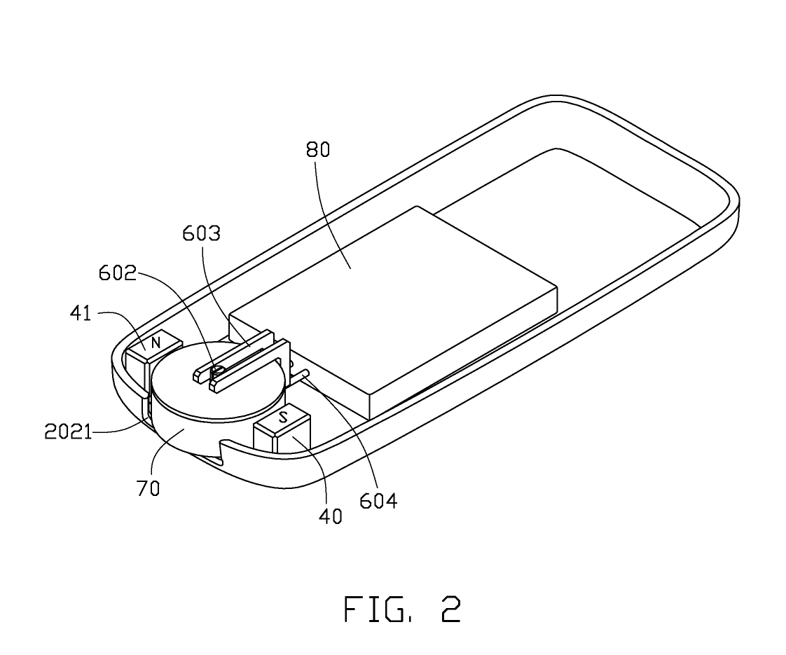

Referring further to FIG.2, in assembly of the self-charging cellular phone 100, the rotating member 50 of the generator 30 is inserted into the receiving cavity 714 of the wheel 70 and hold by the two holding boards 73 of the wheel 70 with two ring collectors 503 thereof exposed out of the opening end 711. The circular disk 72 of the wheel 70 is attached to the circular cylinder 71 and covers the opening end 711 of the circular cylinder 71. At this time, the ring collectors 503 is inserted through the round hole 721 of the circular disk 72 and expose on an upper surface of the circular disk 72. The assembled wheel 70 is rotatably mounted on the lower shell 20 of the self-charging cellular phone 100 via a rotating means (not shown). As such, the assembled wheel 70 is partially accommodated in the second opening 2021 of the lower shell 20. In other words, a part of the assembled wheel 70 is exposed out from the second opening 2021. In this case, the assembled wheel 70 can rotate relative to the lower shell 20.

After that, the pair of magnets S-pole 40 and N-pole 41 is firmly/stably secured (e.g., adhered) on the lower shell 20. The pair of magnets S-pole 40 and N-pole 41 is respectively located adjacent two opposite side ends of the wheel 70. Thus, the wheel 70 is located in a magnetic field generated by the pair of magnets S-pole 40 and N-pole 41. The two electric brushes 603 of the generator 30 respectively contact with the two ring collectors 503 and retain the ring collectors 503 therebetween. The two electric brushes 603 further connect with the rechargeable battery 80 attached on the lower shell 20 via two conductors 604 of the generator 30. Thus, the windings 501 coiled around the armature core 502 of the rotating member 50, the ring collectors 503, the electric brushes 603, and the rechargeable battery 80 are electrically connected in the order written. The upper shell 10 of the self-charging cellular phone 100 then mates with the lower shell 20, which cooperatively form a space to accommodate the wheel 70 therein. Most of the wheel 70 is received in the space enclosed by the upper shell 10 and the lower shell 20. Part of the wheel 70 is exposed out from the first opening 1021 of the upper shell 10 and the second opening 2021 of the lower shell 20.

Referring to FIG. 3, in charging of the self-charging cellular phone 100, the wheel 70 can be rotated via sliding the exposed part of the wheel 70 relative to a board (not labeled) along line A which signifies a rotating/moving direction of the self-charging cellular phone 100. During this process, the rotation of the wheel 70 drives the rotating member 50 to rotate within the magnetic field built up by the pair of magnets S-pole 40 and N-pole 41. Electric current, induced and drawn out from the generator 30, is conducted through the electric brushes 603 to charge the rechargeable battery 80. It is understood that the wheel 70 can otherwise be driven/rotated for facilitating the above charging process of the self-charging cellular phone 100, e.g., the wheel 70 being manually rotated by rotating the part thereof exposed out from the first opening 1021 and the second opening 2021.

It is to be understood that the two holding boards 73 of the wheel 70 of the generator 30 can be omitted. The rotating member 50 can otherwise be attached to (e.g. screwed with, integrally formed with, or the like) the closing end 712 of the cylinder of the wheel 70.

An advantage of the present embodiment embodies that the self-charging cellular phone has a generator built therein. By operating the generator, the rechargeable battery equipped with the self-charging cellular phone can be convenient to be charged with the generator at any place and any time.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A self-charging portable electronic device, comprising:
a rechargeable battery; and
a generator configured for charging the rechargeable battery, comprising:
at least one pair of magnetic N-pole and S-pole configured for creating a magnetic field;
a charging circuit module electrically connecting with the rechargeable battery;
a rotating member located between the at least one pair of magnetic N-pole and S-pole and electrically connected with the charging circuit module; and
a wheel configured to drive the rotating member to generate current to charge the rechargeable battery.

2. The self-charging portable electronic device as claimed in claim 1, wherein the wheel is partially exposed out from the self-charging portable electronic device.

3. The self-charging portable electronic device as claimed in claim 2, further comprising an upper shell and a lower shell, the upper shell and the lower shell are configured to accommodate the wheel therebetween with a part of the wheel exposed out from the lower shell and the upper shell.

4. The self-charging portable electronic device as claimed in claim 3, wherein the upper shell defines a first opening, the lower shell defines a second opening, and the part of the wheel exposed out from at least one of the first and second openings.

5. The self-charging portable electronic device as claimed in claim 1, wherein the rotating member is configured to rotate with the wheel.

6. The self-charging portable electronic device as claimed in claim 5, wherein the rotating member is integrally formed with the wheel.

7. The self-charging portable electronic device as claimed in claim 5, wherein the rotating member is attached with the wheel.

8. The self-charging portable electronic device as claimed in claim 5, wherein the rotating member is hold by the wheel.

9. The self-charging portable electronic device as claimed in claim 8, wherein the wheel defines a receiving cavity and two holding boards, the receiving cavity is located between two holding boards, and the rotating member is hold by the wheel in the receiving cavity.

10. The self-charging portable electronic device as claimed in claim 1, wherein the rotating member comprises an armature core, two ring collectors formed on the armature core, and a set of windings coiled around the armature core, the ring collectors electrically connect with the charging circuit module.

11. The self-charging portable electronic device as claimed in claim 10, wherein the charging circuit module comprises two brushes and two conductors respectively connecting with the two brushes, and the two brushes respectively electrically connect with the two ring collectors.

12. The self-charging portable electronic device as claimed in claim 11, wherein the two brushes retain the ring collectors therebetween.

13. The self-charging portable electronic device as claimed in claim 1, wherein the wheel is rotatably attached with the self-charging portable electronic device.

14. The self-charging portable electronic device as claimed in claim 1, wherein the wheel includes a hollow circular cylinder and a circular disk, the circular disk is configured to cover the circular cylinder, and the at least one pair of magnetic N-pole and S-pole is disposed around the circular cylinder.

15. The self-charging portable electronic device as claimed in claim 1, wherein the circular disk defines a hole therethrough, the rotating member comprises an armature core, two ring collectors, and a set of windings coiled around the armature core, and the rotating member received in the cylinder with the ring collectors engaging through the hole to electrically connect with the charging circuit module.

16. A self-charging portable electronic device, comprising:
a rechargeable battery; and
a generator configured for charging the rechargeable battery, comprising:
at least one pair of magnetic N-pole and S-pole configured for creating a magnetic field;
a charging circuit module electrically connecting with the rechargeable battery;
a wheel rotatably positioned within the self-charging portable electronic device, and positioned between the N-pole and the S-pole;
a rotating member, combined with the wheel, located between the at least one pair of N-pole and the S-pole and electrically connecting with the charging circuit module, wherein the rotating member rotates to generate current to charge the rechargeable battery.

17. The self-charging portable electronic device as claimed in claim 16, wherein the wheel is partially exposed out from the self-charging portable electronic device.

18. The self-charging portable electronic device as claimed in claim 17, further comprising an upper shell and a lower shell, the upper shell and the lower shell are configured to accommodate the wheel therebetween with a part of the wheel exposed out from the lower shell and the upper shell.

19. The self-charging portable electronic device as claimed in claim 16, wherein the wheel defines a receiving cavity and two holding boards, the receiving cavity is located between two holding boards, and the rotating member is hold by the wheel in the receiving cavity.

20. The self-charging portable electronic device as claimed in claim 16, wherein the rotating member comprises an armature core, two ring collectors formed on the armature core, and a set of windings coiled around the armature core, the ring collectors electrically connect with the charging circuit module.
